(19) United States
(12) Patent Application Publication
(10) Pub. No.: US 2009/0098944 A1
(43) Pub. Date: Apr. 16, 2009

(54) Disk for the transmission of a torque in a torque transmission device of a motor vehicle

(75) Inventor: Thomas Weigand, Schweinfurt (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/284,384

(22) Filed: Sep. 22, 2008

(30) Foreign Application Priority Data
Oct. 13, 2007 (DE) 10 2007 049 215.6
Sep. 12, 2008 (DE) 10 2008 042 026.3

(51) Int. Cl. F16D 3/79; F16F 15/12; F16F 15/30

(52) U.S. Cl. 464/99; 192/70.17; 192/207

(57) ABSTRACT

The invention is directed to a disk for the transmission of a torque in a torque transmission device of a motor vehicle. The disk has a radial inner area that can be connected to a first structural component part, a radial outer area that can be connected to a second structural component part, and a quantity of bore holes for the passage of fastening elements for connecting the radial outer area to the second structural component part. In the area between the radial inner area and the radial outer area, the disk has an offset that offsets the two areas relative to one another in axial direction. To employ a long-lasting rivet connection for fastening the disk in an economical manner, the invention incorporates at least one recess in the disk in the area of the offset.

### FIELD OF THE INVENTION

The invention is directed to a disk for transmitting a torque in a torque transmission device of a motor vehicle, this disk having a radial inner area which can be connected to a first structural component part, a radial outer area which can be connected to a second structural component part, and a quantity of bore holes for the passage of fastening elements for connecting the radial outer area to the second structural component part. The disk has in the area between the radial inner area and the radial outer area a bend or offset which offsets the two areas relative to one another in axial direction.

### DESCRIPTION OF THE RELATED ART

A disk for transmitting a torque in a torque transmission device of a motor vehicle is known from DE 41 17 580 C2. This reference describes a divided flywheel as a component part of the drivetrain of a motor vehicle in which a disk, referred to as a membrane-like structural component part, is used. This disk, which is formed of thin sheet metal, has, near its radial outer rim, an offset that produces a certain axial offset between the radial inner area of the disk and the radial outer area of the disk that is necessary for the design described therein. Apart from some passages located radially inside the offset, the disk is free of recesses. The disk is fastened to the adjoining structural component part in the radial outer area by means of a rivet connection, i.e., by a quantity of rivets arranged along the circumference of the disk.

A similar solution is described in DE 44 02 257 C2. DE 100 47 242 C1 discloses a similar disk, although it is not provided with an offset.

In disks of the type mentioned above—which are also sometimes known as flexplates—i.e., plates which have an offset and are connected on the radial outer side to an adjoining structural component part by a rivet connection. It has proven disadvantageous that cross tension or head strain occurs in the region of the outer connection which can lead to peeling of the plate from the adjoining structural component at the connection element and is particularly severe when rivets are used. This is caused by wobbling movements carried out by the arrangement during operation.

This problem can be countered by using the screw as a connecting element. This screw is substantially less susceptible to head strain than a rivet. However, the screw connection is considerably more expensive than a rivet connection. Further, the screw connection takes up more space than the rivet connection.

Therefore, in many cases a rivet can be adequately designed with respect to tension only by reducing head strain. Yet this is often problematic in terms of design.

### SUMMARY OF THE INVENTION

Accordingly, it is an object of the invention to develop a disk of the type mentioned above in such a way that it is possible to provide an inexpensive rivet connection in the radial outer area of a disk for fastening the disk to the adjoining structural component part while nevertheless ensuring a sufficiently long life of the connection while preventing peeling. The head strain on the connection element should also be reduced in the presence of wobbling movements.

This object is met by the invention in that at least one recess is incorporated in the disk in the area of the offset of the disk.

A plurality of recesses are preferably arranged so as to be distributed along the circumference of the disk.

The recess preferably lies on a radial ray extending from the axis of rotation of the disk to the bore hole for the fastening element.

The disk is advantageously formed of a thin sheet metal.

A rivet is preferably used as fastening element, which has corresponding advantages with respect to cost.

Various solutions have proven successful for the geometric shape of the recess.

The recess can be constructed as an elongated hole, which preferably extends in circumferential direction of the disk.

The recess can also be oval or elliptical.

Further, the recess can be constructed as an elongated hole or oval preferably extending in circumferential direction and has a widened portion that is directed radially inward or radially outward in at least one location on the circumference. In this case, there is preferably an individual widened portion that is directed radially inward or radially outward and is arranged in the middle of the recess considered in circumferential direction.

The extension of the recess in circumferential direction can be such that radial rays of two adjacent bore holes extending from the axis of rotation to the bore hole for the fastening element intersect the recess.

Further, the recess can be circular.

Further, the recess can have a U-shaped contour.

In a further embodiment, recesses are arranged on at least two different radii. In this case, the recesses arranged on the two different radii are arranged so as to be offset relative to one another in circumferential direction.

Head strain originates from the axial expansion, i.e., through the offset of the disk (i.e., the flexplate) particularly during the wobbling movement of the device in which it is installed and the head strain is transmitted from the disk to the fastening elements (rivets), relief recesses are provided according to the invention in the area of the offset and specifically influence the introduction of force. When material is removed in the area of the offset, only shear forces can be transmitted in the connection area. The bending moment, which severely stresses the connection, is substantially reduced. This appreciably reduces the loading of the fastening elements. Therefore, it is possible to use rivet connections to fasten the disk to the adjoining structural component part. These rivet connections, although inexpensive, have a sufficiently long life.

The present invention is suitable in general to be used wherever a disk with an offset must be connected to an adjoining structural component part in a stable and economical manner.

Examples of the invention are shown in the drawing.

The various features, which characterize the invention, are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

In the drawings:

FIG. 1 is a perspective view, in section, showing a rotor adapted to be connected to a crankshaft of an internal combustion engine, wherein a rotationally rigid connection is produced by means of a disk;

FIG. 2 shows the disk for producing the rotationally rigid connection in a front view according to a first embodiment form of the invention;

FIG. 3 shows the disk from FIG. 2 according to a second embodiment of the invention;

FIG. 4 shows the disk from FIG. 2 according to a third embodiment of the invention;

FIG. 5 shows the disk from FIG. 2 according to a fourth embodiment of the invention;

FIG. 6 shows the disk from FIG. 2 according to a fifth embodiment of the invention;

FIG. 7 shows the disk from FIG. 2 according to a sixth embodiment of the invention;

FIG. 8 shows the disk from FIG. 2 according to a seventh embodiment of the invention;

FIG. 9 shows the disk from FIG. 2 according to an eighth embodiment of the invention; and

FIG. 10 shows the disk from FIG. 2 according to a ninth embodiment of the invention.

### DETAILED DESCRIPTION OF THE PRESENTLY PREFERRED EMBODIMENTS

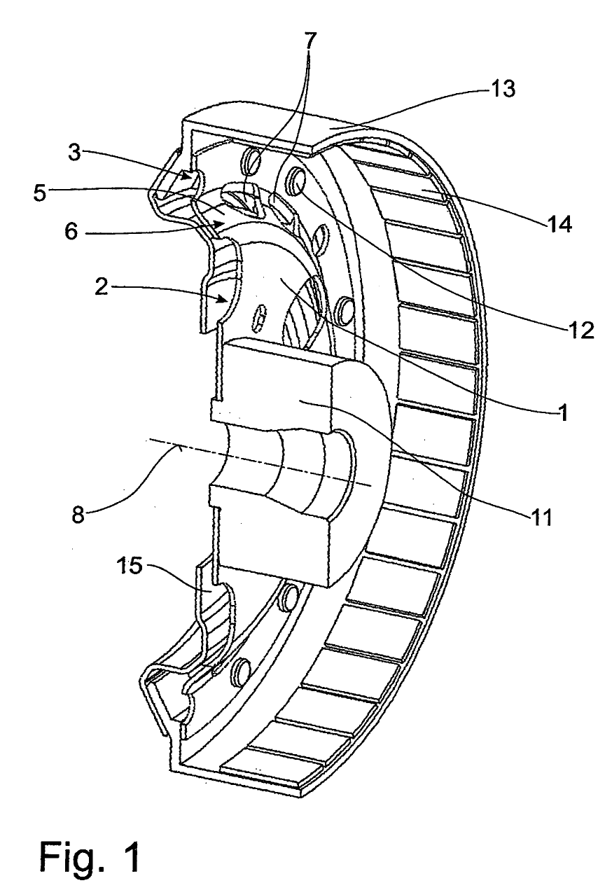

FIG. 1 shows a detail of a portion of a drivetrain of a motor vehicle. The drawing shows a torque transmission device in which a crankshaft adapter 11 is connected to a crankshaft (not shown) of an internal combustion engine. A disk 1 (flexplate) of thin sheet metal is connected to the crankshaft adapter 11 so as to be fixed with respect to rotation relative to it. Disk 1 is connected by its radial outer area to an adjoining structural component part, a rotor 13 of an electric machine in the embodiment example, by means of a quantity of rivets 12 so as to be fixed with respect to rotation relative to it. The rotor 13 has a quantity of magnets 14, although these magnets 14 are not significant in relation to the present invention.

A disk 15 (driveplate) is connected to the rotor 13 so as to be fixed with respect to rotation relative to it is also not relevant to the present invention. The disk 15 is connected to a torque converter so as to be fixed with respect to rotation relative to it, although this is not shown in the drawing.

As can further be seen from FIG. 1, the radial inner area 2 of the disk 1 is arranged to be axially offset relative to the radial outer area 3 of the disk. The transition from the radial inner area to the radial outer area is formed by an offset 5 is arranged in an area 6. A corresponding bending of the disk 1 generates the offset 5 as can be seen from FIG. 1.

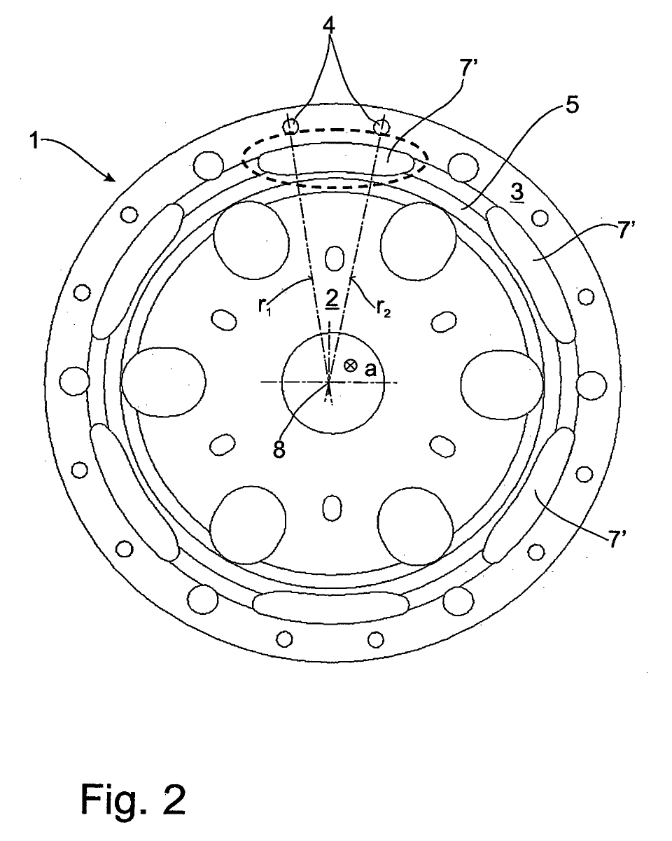

At least one recess 7 is incorporated in the disk 1 in the area 6 of the offset 5. In one embodiment, the recess 7 is produced by punching. The different preferred possibilities for shaping the recesses 7 in the disk 1 are shown by FIGS. 2 to 10.

In FIG. 2 recesses 7′ (see the arrangement within the oval shown in dashed lines here and in the other drawings) have the shape of an elongated hole. Further, the extension of the recess 7′ in circumferential direction of the disk 1 is such that the radial rays r₁ and r₂ to two adjacent bore holes 4 for the passage of a rivet to the axis of rotation 8 of the disk 1 intersect the recess 7′. In this way elasticity of the disk 1 is achieved in the area of the rivet connection so that the expansion of forces to the rivet heads is kept small to provide a stable arrangement with a long service life.

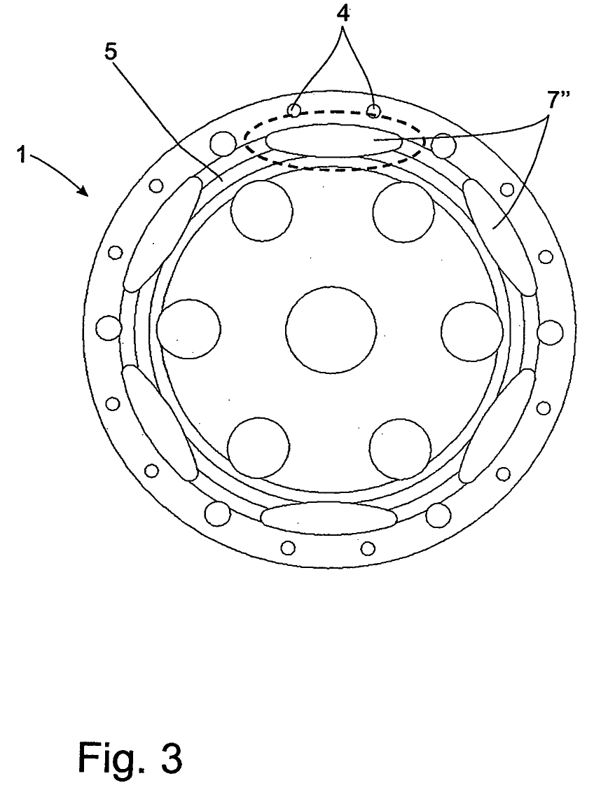

The alternative according to FIG. 3 shows a similar shaping of the recesses. In this case, the recesses 7″ have an oval or elliptical contour. As is shown in FIG. 2, a quantity of recesses 7″—in this case, six—are distributed equidistantly along the circumference of the disk 1. Apart from the recesses 7 and the bore holes 4 for the passage of the rivets, the disk 1 can have additional recesses as is shown in the various embodiments. These additional recesses are arranged outside of the areas 6 of the offset 5 and are already known per se.

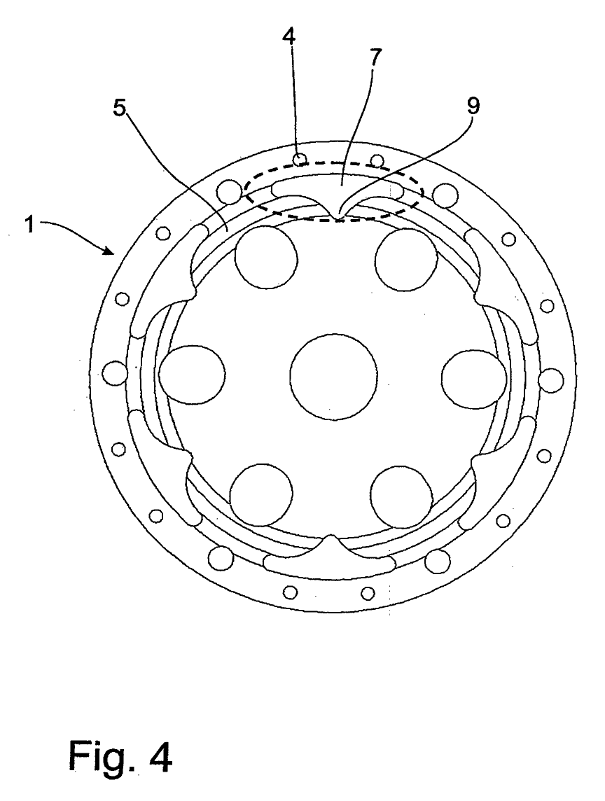

In the embodiment according to FIG. 4, the recesses 7 have a contour in the shape of an elongated hole, but every recess 7 now has a nose-shaped widened portion 9 which is directed radially inward. Accordingly, the area 6 of the offset 5 is completely interrupted at certain points on the circumference. The widened portions 9 afford advantages with respect to the softness of the disk 1 relative to wobbling.

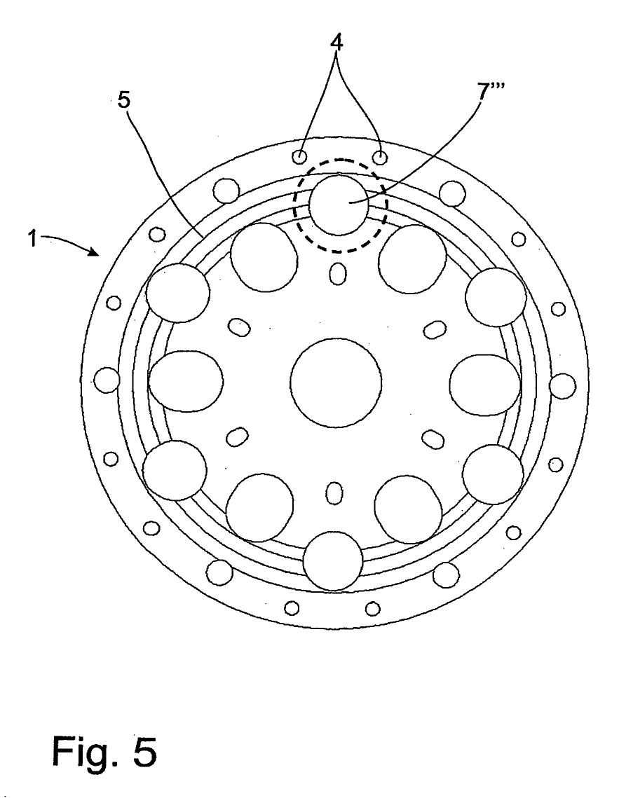

The solution according to FIG. 5 shows recesses 7′″ with a circular contour incorporated in the area 6 of the offset 5. This solution is very simple with respect to manufacturing technique and is accordingly economical. The solution is particularly advantageous in applications with reduced loads.

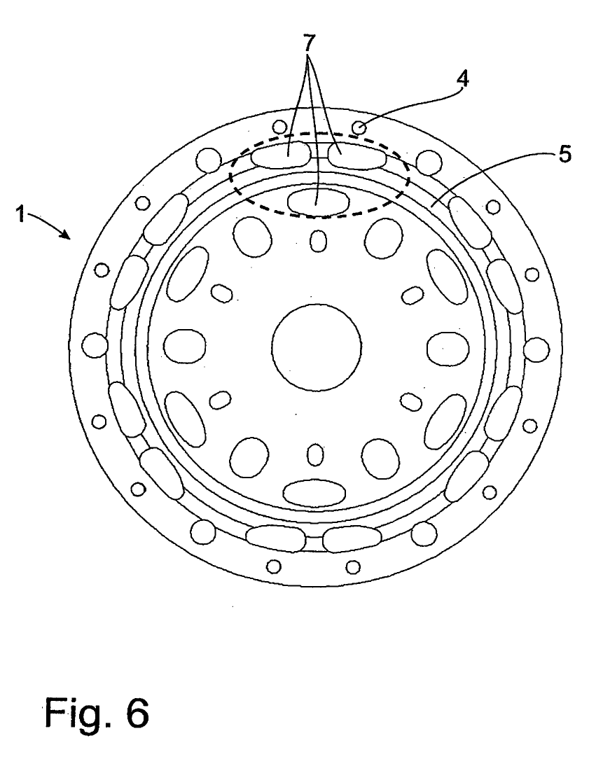

In the construction according to FIG. 6, the recesses 7 are arranged on a plurality of radii, namely on two different radii, in the area 6 of the offset 5. The loading of the rivets can be further reduced in this way.

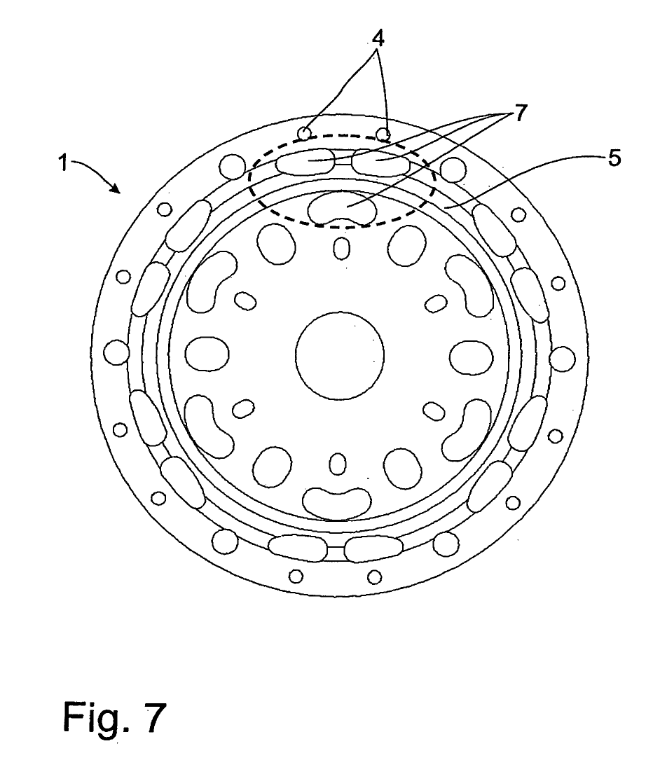

FIG. 7 shows a variant of FIG. 6 with kidney-shaped radial inner recesses 7.

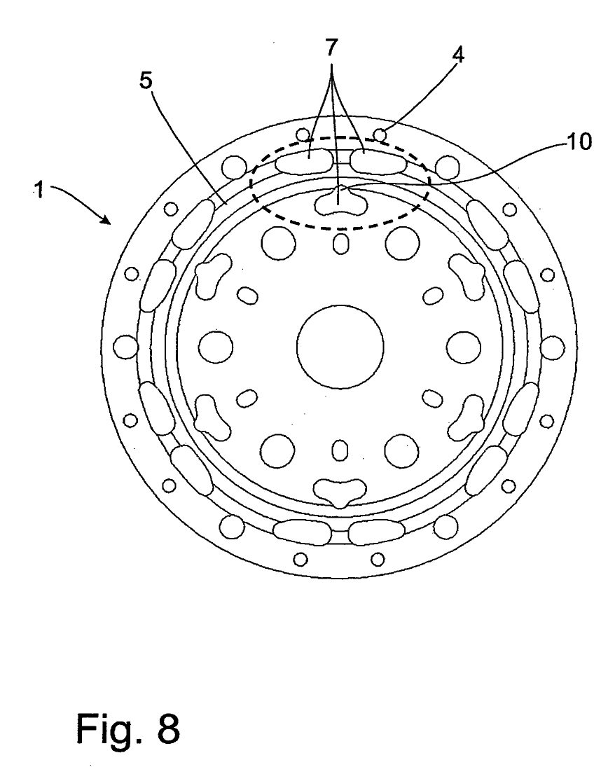

FIG. 8 shows that the recesses 7—in this case the radial inner recesses—can have a portion 10 which faces radially outward and which is shaped similar to the portion 9 according to FIG. 4.

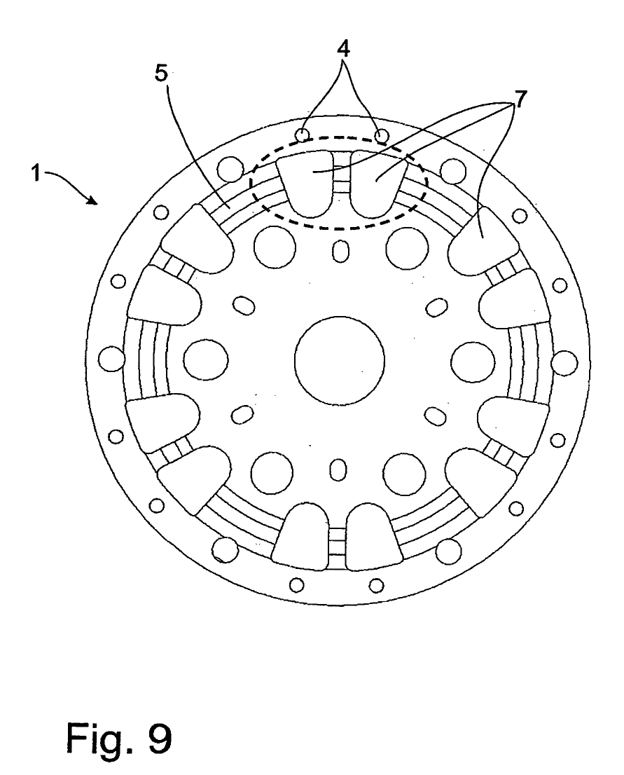

FIG. 9 shows recesses 7 having a U-shaped outline. As can be seen, a U-shaped recess 7 is associated with every bore hole 4 for the passage of the rivet. This solution is particularly suitable for a soft connection of the disk 1 under small loads.

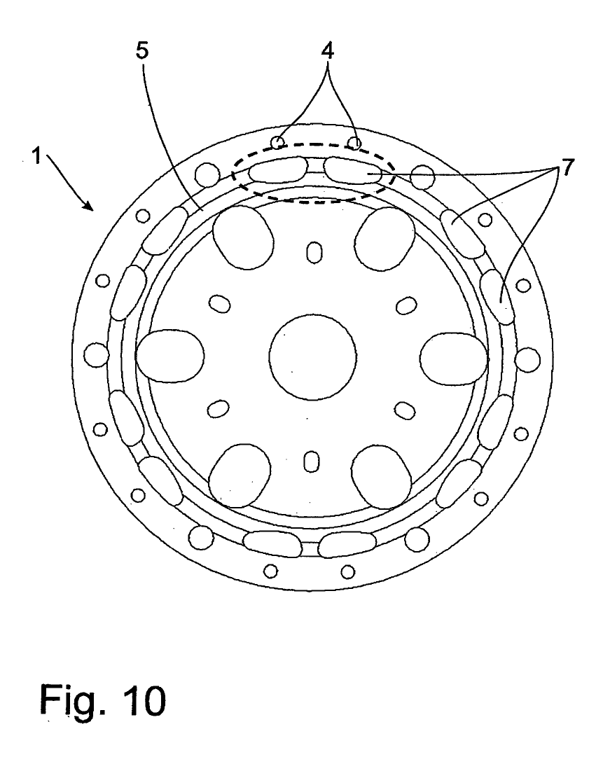

FIG. 10 shows a variant comprising webs which are approximately 20 percent stiffer than the construction according to FIG. 2 with respect to deformation characteristics.

The invention is not limited by the embodiments described above which are presented as examples only but can be modified in various ways within the scope of protection defined by the appended patent claims.

I claim:

1. A disk for the transmission of a torque in a torque transmission device of a motor vehicle, comprising:
a radial inner area configured for connection to a first structural component part;
a radial outer area configured for connection to a second structural component part, wherein the radial outer area has at least one bore hole for the passage of a fastening element for connecting the radial outer area to the second structural component part; and
an offset coupling the radial inner area to the radial outer area which offsets the two areas relative to one another in an axial direction, wherein at least one recess is incorporated in the offset.

2. The disk according to claim 1, wherein a plurality of recesses are distributed equidistantly along a circumference of the disk in the offset.

3. The disk according to claim 1, wherein the at least one recess lies on a radial ray extending from an axis of rotation of the disk to the bore hole.

4. The disk according to claim 1, wherein the disk is formed of a thin sheet metal.

5. The disk according to claim 1, wherein the fastening elements are rivets.

6. The disk according to claim 1, wherein the recess is shaped as an elongated hole, the elongated hole being elongated in a circumferential direction of the disk.

7. The disk according to claim 1, wherein the at least one recess is oval or elliptical.

8. The disk according to claim 1, wherein the at least one recess has a widened portion that is directed radially inward.

9. The disk according to claim 1, wherein the at least one recess has a widened portion that is directed radially outward.

10. The disk according to claim 8, wherein the widened portion is arranged in the middle of the at least one recess in a circumferential direction.

11. The disk according to claim 6, wherein the extension of the at least one recess in circumferential direction is configured such that radial rays to two adjacent bore holes, extending from an axis of rotation to the two adjacent bore holes, intersect the at least one recess.

12. The disk according to claim 1, wherein the at least one recess is circular.

13. The disk according to claim 1, wherein the at least one recess has a U-shaped contour.

14. The disk according to claim 2, wherein each of the recesses is arranged on at least two different radial rays, each radial ray extending from an axis of rotation of the disk to a bore hole.

15. The disk according to claim 14, wherein the recesses are offset relative to one another in a circumferential direction.

16. The disk according to claim 9, wherein the widened portion is arranged in the middle of the recess in circumferential direction.
